(19) United States
(12) Patent Application Publication
(10) Pub. No.: US 2025/0287421 A1
(43) Pub. Date: Sep. 11, 2025

(54) SIDELINK LBT TYPE INDICATION FOR UE TO UE COT SHARING

(71) Applicant: Lenovo (Singapore) Pte. Limited, Singapore (SG)

(72) Inventors: Karthikeyan Ganesan, NAUHEIM (DE); Ravi Kuchibhotla, CHICAGO, IL (US)

(21) Appl. No.: 18/858,322

(22) PCT Filed: Apr. 21, 2023
(86) PCT No.: PCT/IB2023/054107

§ 371 Date: Oct. 20, 2024

Related U.S. Application Data
(60) Provisional application No. 63/333,479, filed on Apr. 21, 2022.

(51) Int. Cl. H04W 74/0808; H04W 74/00

(52) U.S. Cl. CPC H04W 74/0808; H04W 74/002

(57) ABSTRACT

A user equipment (UE) is configured to share sub-channel resources from among available sidelink channel resources with second UEs. The device transmits a sidelink channel occupancy sharing indicator that enables at least two devices to transmit data utilizing available sidelink channel resources within a channel occupancy duration. The sidelink channel occupancy sharing indicator includes a value for a selected listen before talk (LBT) type from among multiple LBT types for channel sensing. The LBT type signals, to a second UE receiving the sidelink channel occupancy sharing indicator, which LBT procedure to utilize before accessing resources identified by the sharing indicator. The UE allocates the available sidelink channel resources to the at least two second UEs to enable multiple devices to cooperatively share available sidelink channel resources via non-overlapping time or frequency domain usage in order to achieve a channel occupancy threshold level of resource utilization in an unlicensed spectrum.

### RELATED APPLICATION

This application claims priority to U.S. provisional application No. 63/333,479, filed Apr. 21, 2022, the content of which is fully incorporated herein.

### TECHNICAL FIELD

The present disclosure relates to wireless communications, and more specifically to wireless communications with sidelink (SL) channel occupancy time (COT) sharing between user equipments (UEs).

### BACKGROUND

A wireless communications system may include one or multiple network communication devices, such as base stations, which may be otherwise known as an eNodeB (eNB), a next-generation NodeB (gNB), or other suitable terminology. Each network communication device, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G.

Some wireless communications systems support SL COT sharing between a user equipment (UE) and a base station and between a first UE and at least one second UE. Such UE-to-UE COT sharing allows a first UE to acquire a COT and share the COT with other UE(s) within communication range of the first UE.

### SUMMARY

The present disclosure relates to methods, apparatuses, and systems that support wireless communication by a device. A communication device (e.g., a UE) is configured to initiate UE-to-UE sidelink channel resource sharing by which a device/UE shares sub-channel resources from among available sidelink channel resources with one or more second devices (i.e., other UEs). The device initiates sharing by transmitting a sidelink channel occupancy sharing indicator that enables at least two devices to transmit data utilizing the available sidelink channel resources within a channel occupancy duration. The sidelink channel occupancy sharing indicator includes a value for a selected listen before talk (LBT) type for channel sensing. In accordance with the LBT type, the device allocates the available sidelink channel resources to enable multiple devices to share available sidelink channel resources in order to achieve enhanced sidelink bandwidth utilization efficiency.

According to one or more embodiments of the present disclosure, the available sidelink channel resources are an available channel occupancy time (COT) which includes configured frequency and time domain resources.

Some implementations of the method and apparatuses described herein may further include the device transmitting, via a transceiver, a sidelink channel occupancy sharing indicator that enables at least two devices to transmit data utilizing available sidelink channel resources within a channel occupancy duration. The sidelink channel occupancy sharing indicator comprises a value for a selected listen before talk (LBT) type from among multiple LBT types for channel sensing. A selected LBT type signals to a second device receiving the sidelink channel occupancy sharing indicator which LBT procedure to utilize before accessing resources identified by the sidelink channel occupancy sharing indicator. The device is configured to allocate the available sidelink channel resources to the at least two devices to enable multiple devices to cooperatively share available sidelink channel resources via non-overlapping time or frequency domain usage in order to achieve a channel occupancy threshold level of resource utilization in an unlicensed spectrum.

In some implementations of the method and apparatuses described herein, at least one LBT type may indicate that resources identified by the sidelink channel occupancy sharing indicator can be accessed without utilizing an LBT procedure and/or without performing channel sensing. According to an implementation, the at least one LBT type is a first LBT type, which indicates a No-LBT type/category. Furthermore, some additional LBT types for channel sensing may signal to a second device receiving the sidelink channel occupancy sharing indicator a corresponding category of LBT procedures to utilize before accessing resources identified by the sidelink channel occupancy sharing indicator. These additional LBT types include a Category 2 (CAT 2) LBT based on an energy sensing procedure and a Category 4 (CAT 4) LBT based on a clear channel assessment procedure.

In some implementations of the method and apparatuses described herein, the initiating device monitors, for a preset time period, for one or more of (i) a feedback message indicating the second device will utilize the allocated resources and (ii) transmission activity within allocated sidelink channel resources from the second device receiving the sidelink sharing information. In response to not receiving the feedback message and not detecting transmission activity by the second device within the allocated sidelink channel resources, the initiating device initiates data transmission utilizing the allocated sidelink channel resources within a corresponding resource duration.

According to one or more aspects of the present disclosure, the second device receives, from the sidelink sharing device (e.g., the initiating device) via a transceiver, a sidelink channel occupancy sharing indicator that identifies, from among available sidelink channel resources, specific sidelink channel resources that the device can utilize to transmit data. The sidelink channel occupancy sharing indicator includes a value for an LBT type from among multiple types of channel sensing. According to an aspect, the LBT type indicates which LBT procedure to utilize before the device initiates transmitting data over the sidelink channel resources. Additionally, the second device determines whether the second device is able to utilize the identified sidelink channel resources to transmit data. In addition, the second device transmits the data over the sidelink channel resources in accordance with the LBT procedure, in response to the second device being able to utilize the sidelink channel resources.

Some implementations of the method and apparatuses described herein may further include the second device receiving, from a sidelink sharing device (e.g., the initiating device) via the transceiver, a sidelink channel occupancy sharing indicator that identifies, from among available sidelink channel resources, specific sidelink channel resources that the second device can utilize to transmit data. The sidelink channel occupancy sharing indicator includes a value for an LBT type from among multiple types of channel sensing. According to an aspect, the LBT type indicates which LBT procedure to utilize before the device initiates transmitting data over the sidelink channel resources. Implementations of the method and apparatuses described herein may further include the second device determining whether the second device is able to utilize the identified sidelink channel resources to transmit data, and the second device transmitting the data over the sidelink channel resources in accordance with the LBT procedure, in response to the second device being able to utilize the sidelink channel resources.

### BRIEF DESCRIPTION OF THE DRAWINGS

Various aspects of the present disclosure for enabling user equipment initiated channel occupancy time (COT) sharing between user equipments in accordance with an LBT type are described with reference to the following Figures. The same numbers may be used throughout to reference like features and components shown in the Figures.

FIG. 1 illustrates an example of a wireless communications system that supports channel occupancy time (COT) sharing between user equipments, in accordance with aspects of the present disclosure.

FIG. 2A illustrates a system by which sidelink channel occupancy time sharing indication is signaled by group-casting a COT indicator to second user equipments, in accordance with aspects of the present disclosure.

FIG. 2B illustrates a system by which sidelink channel occupancy time sharing indication is signaled by unicasting different COT indicators, with corresponding LBT types, in accordance with aspects of the present disclosure.

FIG. 3A is a schematic block diagram illustrating one embodiment of sidelink (SL) UE initiated COT sharing with the UEs engaged in non-overlapping resource usage, in accordance with aspects of the present disclosure.

FIG. 3B is a schematic block diagram illustrating one embodiment of sidelink (SL) UE initiated COT sharing, where a second UE does not utilize the allocated COT resources, in accordance with aspects of the present disclosure.

FIG. 4 is a signal flow timing diagram illustrating one embodiment of UE initiated COT sharing with unique LBT types, in accordance with aspects of the present disclosure.

FIG. 5 is a signal flow timing diagram illustrating another embodiment of UE initiated COT sharing with originating UE use of unused COT resources, in accordance with aspects of the present disclosure.

FIG. 6 illustrates an example of subchannels by which an initiating UE provides a COT sharing indicator with LBT type to a second device, in accordance with aspects of the present disclosure.

FIG. 7 is a diagram illustrating one embodiment of a first interlacing scheme for sidelink operation, in accordance with aspects of the present disclosure.

FIG. 8 is a diagram illustrating one embodiment of a second interlacing scheme for sidelink operation, in accordance with aspects of the present disclosure.

FIG. 9 is a diagram illustrating one embodiment of a third interlacing scheme for sidelink operation, in accordance with aspects of the present disclosure.

FIG. 10 is a block diagram illustrating one embodiment of a user equipment apparatus that may be used for initiating sidelink channel occupancy time sharing between user equipments, in accordance with aspects of the present disclosure.

FIGS. 11, 12, and 13 are flowcharts of methods that support user equipment initiated sidelink channel occupancy time sharing between user equipments based on LBT types, in accordance with aspects of the present disclosure.

### DETAILED DESCRIPTION

Wireless devices are being configured to support sidelink operation on unlicensed spectrum. For sidelink operation over the unlicensed spectrum, e.g., for channels such as Physical Sidelink Shared Channel (“PSSCH”), Physical Sidelink Control Channel (“PSCCH”), etc., transmissions are required/expected to meet a Power Spectrum Density (“PSD”) regulation and minimum channel occupancy requirement (e.g., 80%). To fulfill these regulations, interlacing schemes may be used in Long Term Evolution Unlicensed spectrum (LTE-unlicensed) and New Radio Unlicensed spectrum (NR-unlicensed) that interlace physical channels, e.g., PSSCH and PSCCH channels, at resource block level.

With sidelink (SL) resource allocation, the minimum scheduling unit (i.e., defined by subchannel consisting of ‘N’ PRBs and ‘M’ subchannels) constitutes a resource pool. Each sidelink (SL) carrier contains one SL Bandwidth Part (“BWP”) which is then associated with multiple transmission (“Tx”) resource pools containing different configuration of the subchannel sizes {n10, n12, n15, n20, n25, n50, n75, n100}. The minimum scheduling unit of subchannel for sidelink contradicts that of uplink, which is based on RB level scheduling unit, and each resource pool in the sidelink does not span across an entire bandwidth or LBT subbands, which is the requirement for minimum occupancy and PSD limit.

To meet the regulatory requirements of PSD and the minimum channel occupancy (80%), sidelink unlicensed operation requires interlacing of subchannels and/or resource pools. However, another challenge of sidelink unlicensed operation is that the UE is not expected to use the remaining PRBs in Rel-16 sidelink design. Unlike a next-generation NodeB (gNB) which has a much greater data storage and communication capacity, the UE may not utilize the entire LBT bandwidth for data transmission. This expectation of an inadequate use of resources is problematic for unlicensed operation, as the resource usage might not meet the minimum occupancy requirement.

Generally, the present disclosure describes systems, methods, and apparatus for meeting the regulatory requirements of PSD and also provide the minimum channel occupancy requirement for UE-to-UE sidelink operation in shared unlicensed spectrum. In certain embodiments, the methods may be performed using computer code embedded on a computer-readable medium. In certain embodiments, an apparatus or system may include a computer-readable medium containing computer-readable code which, when executed by a processor, causes the apparatus or system to perform portions of the below described solutions.

According to one or more aspects of the present disclosure, the method, apparatus, and system described herein enable a device (e.g., a handheld UE, a vehicular UE) to initiate sharing of a COT with other devices, using an assigned/indicated LBT type from among multiple LBT types, in order to promote more efficient utilization of unoccupied and/or underutilized time domain resources and/or frequency domain resources in the COT. According to one or more aspects, unoccupied frequency resources arranged in an interlacing configuration can be utilized by other UEs in order for sidelink channel occupancy requirements to be satisfied. According to an aspect, the device performs and/or requests that other UEs perform channel monitoring/sensing, based on the assigned/indicated LBT type, to ensure that allocated resources do not remain unused.

In accordance with one embodiment, the initiating UE of the COT is configured to initiate UE-to-UE sidelink channel resource sharing by which the initiating UE shares sub-channel resources from among available sidelink channel resources (within a COT or remaining COT) with one or more second devices (i.e., other UEs). The initiating UE initiates sharing by transmitting a sidelink channel occupancy sharing indicator that enables at least two devices to transmit data utilizing the available sidelink channel resources within a channel occupancy duration. The sidelink channel occupancy sharing indicator includes a value for a selected LBT type for channel sensing. The initiating UE allocates the available sidelink channel resources in accordance with the LBT type to enable multiple devices to share the available sidelink channel resources in order to achieve enhanced sidelink bandwidth utilization efficiency.

As utilized herein, the term “initiating UE” refers to the device from which the COT sharing is initiated. The other devices to which the COT is shared are referred to as second devices or second UEs.

In accordance with another embodiment, a second device receives, from the initiating UE, the sidelink channel occupancy sharing indicator, which includes the LBT type value for channel sensing. The second device determines whether the second device is able to utilize the identified sidelink channel resources to transmit data. According to an aspect, the second device makes the determination of its ability to utilize the identified sidelink channel resources based on whether the second device can successfully perform a specified LBT procedure (corresponding to the received LBT type) and/or whether the device has data to be transmitted. The second device transmits the data over the sidelink channel resources in accordance with the LBT procedure, in response to the second device being able to utilize the sidelink channel resources.

According to one or more aspects of the present disclosure, the initiating device provides enhanced sidelink resource utilization efficiency by having multiple second devices contend for available resources utilizing a specified channel sensing procedure. According to an aspect, to further facilitate achieving sidelink channel occupancy requirements, the initiating device performs channel monitoring/sensing and transmits data using any unused resources to ensure that allocated resources do not remain unused. The initiating device (i.e., the COT initiator/COT donor, which is the Tx UE) is not aware which COT recipient has intention to transmit in the shared COT and is not aware of the how much data transmission the COT recipient intends to make. Hence, mechanisms such as a feedback message is needed to facilitate awareness at the initiating device (COT donor or Tx UE) to determine the responding COT recipient. For example, the COT donor may not be aware which of the group member(s) within a group receiving a group cast of the COT sharing indicator intends to become a transmitter UE, and without this information, the COT donor could waste the COT duration by blindly transmitting the COT sharing indicator to UEs or destinations.

According to one or more embodiments of the present disclosure, the initiating device monitors, for a preset time period, for one or more of (i) a feedback message indicating the second device will utilize the allocated resources or intend to become a transmitter within the remaining COT duration and (ii) transmission activity within allocated sidelink channel resources from the second device receiving the sidelink sharing information. In response to not receiving the feedback message and not detecting transmission activity by the second device within the allocated sidelink channel resources, the initiating device initiates data transmission utilizing the allocated sidelink channel resources within a corresponding resource duration. In one method, the feedback message may be transmitted after the reception of the COT sharing indicator indicating that the COT recipient UE may intend to make a transmission in the remaining COT and, optionally, the duration the COT recipient UE intends to utilize to make the transmission. The timing information for the transmission of this feedback message after the reception of the COT sharing indicator may be (pre)configured in a resource pool or otherwise dynamically signaled in the SCI. The PSFCH resource may be used to transmit the feedback message. In another method, the feedback message may be transmitted before the reception of the COT sharing indicator from a COT donor or using the short control signaling exemption as a groupcast or as a unicast feedback message using a (pre)configured resource in the resource pool to facilitate awareness at the COT donor or Tx UE of the intention of the COT recipient. The validity or latency of such feedback message should be (pre)configured in terms of time slot or msec.

As a result of a shared usage of available sidelink channel resources, multiple devices, including the initiating device and at least one second device (CO recipient UE), are able to cooperatively share available sidelink channel resources via non-overlapping time or frequency domain usage in order to achieve a channel occupancy threshold level of resource utilization in an unlicensed spectrum.

Aspects of the present disclosure are described in the context of a wireless communications system. Aspects of the present disclosure are further illustrated and described with reference to device diagrams, flowcharts that relate to user equipment initiated sidelink channel occupancy time sharing between user equipments based on the LBT type identified within the sidelink channel occupancy sharing indicator.

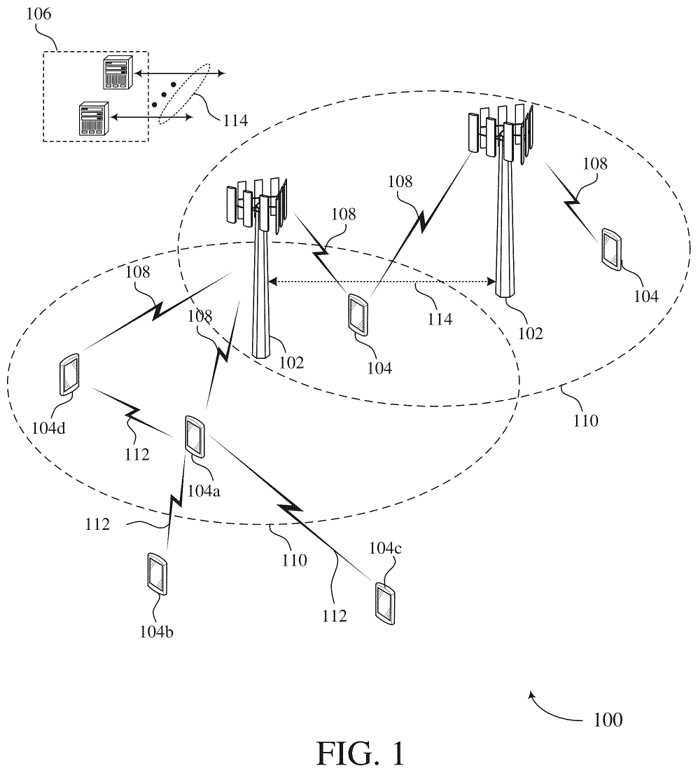

FIG. 1 illustrates an example of a wireless communications system 100 that supports user equipment initiated sidelink channel occupancy time sharing between user equipments based on the LBT type identified within the sidelink channel occupancy sharing indicator in accordance with aspects of the present disclosure. The wireless communications system 100 may include one or more base stations 102, one or more UEs (collectively UEs 104), and a core network 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more base stations 102 may be dispersed throughout a geographic region to form the wireless communications system 100. One or more of the base stations 102 described herein may be or include or may be referred to as a base transceiver station, an access point, a NodeB, an eNodeB (eNB), a next-generation NodeB (gNB), or other suitable terminology. A base station 102 and a UE 104 may communicate via a communication link 108, which may be a wireless or wired connection. For example, a base station 102 and a UE 104 may wireless communication over a Uu interface.

A base station 102 may provide a geographic coverage area 110 for which the base station 102 may support services (e.g., voice, video, packet data, messaging, broadcast, etc.) for one or more UEs 104 within the geographic coverage area 110. For example, a base station 102 and a UE 104 may support wireless communication of signals related to services (e.g., voice, video, packet data, messaging, broadcast, etc.) according to one or multiple radio access technologies. In some implementations, a base station 102 may be moveable, for example, a satellite associated with a non-terrestrial network. In some implementations, different geographic coverage areas 110 associated with the same or different radio access technologies may overlap, but the different geographic coverage areas 110 may be associated with different base stations 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. A UE 104 may be capable of communicating with various types of devices, such as the base stations 102, other UEs 104, or network equipment (e.g., the core network 106, a relay device, an integrated access and backhaul (IAB) node, or another network equipment), as shown in FIG. 1. Additionally, or alternatively, a UE 104 may support communication with other base stations 102 or UEs 104, which may act as relays in the wireless communications system 100.

A UE 104 may also be able to support wireless communication directly with other UEs 104 over a communication link 112. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 112 may be referred to as a sidelink. For example, a UE 104 may support wireless communication directly with another UE 104 over a PC5 interface.

A base station 102 may support communications with the core network 106, or with another base station 102, or both. For example, a base station 102 may interface with the core network 106 through one or more backhaul links 114 (e.g., via an S1, N2, N2, or another network interface). The base stations 102 may communication with each other over the backhaul links 114 (e.g., via an X2, Xn, or another network interface). In some implementations, the base stations 102 may communicate with each other directly (e.g., between the base stations 102). In some other implementations, the base stations 102 may communicate directly with each other or indirectly (e.g., via the core network 106). In some implementations, one or more base stations 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management for the one or more UEs 104 served by the one or more base stations 102 associated with the core network 106.

According to one aspect and as presented by the illustrated embodiments, a first UE 104a, also referred to herein as an initiating UE 104a, establishes a sidelink sharing channel, e.g., a channel occupancy time (COT) sharing, with three neighboring second UEs 104b-104d and provides a specific LBT type indication within the COT message.

In certain embodiments, one or more of the second UEs 104b-104d may perform an LBT procedure, based on the LBT type indicated, in order to access sub-channel resources of sidelink channel resources. In some embodiments, the second UEs 104b-104d initiate channel occupancy time sharing for the second UEs 104b-104d based on the LBT procedure identified by the LBT type. In other embodiments, a No-LBT type indication indicates that the second UE 104b-104d can utilize the COT resources without performing a channel sensing procedure.

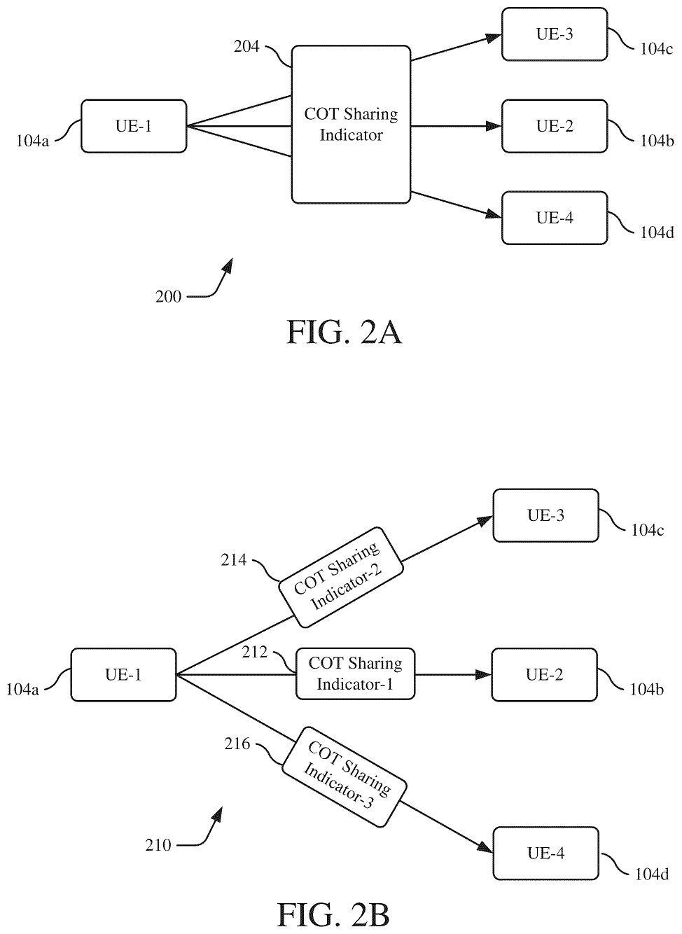

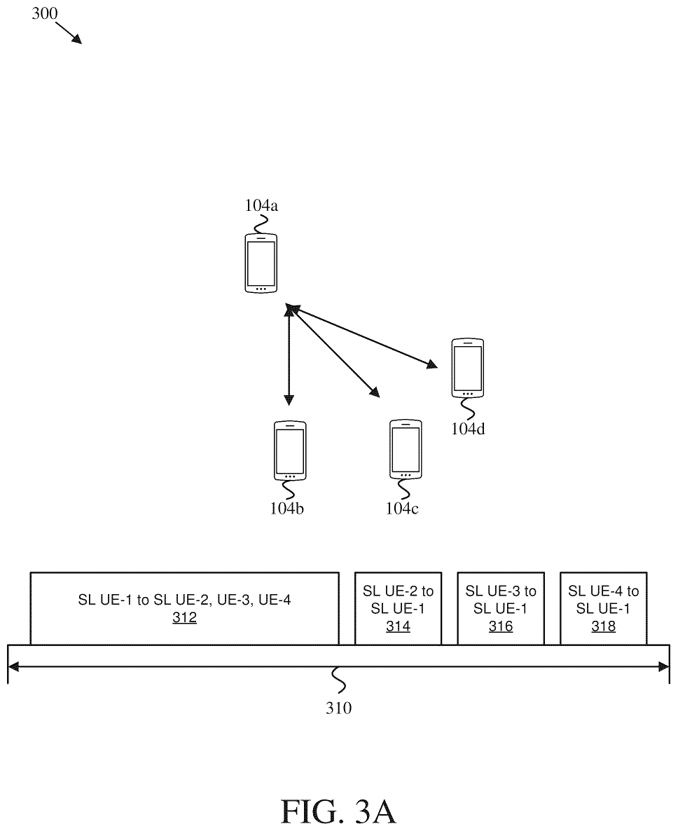

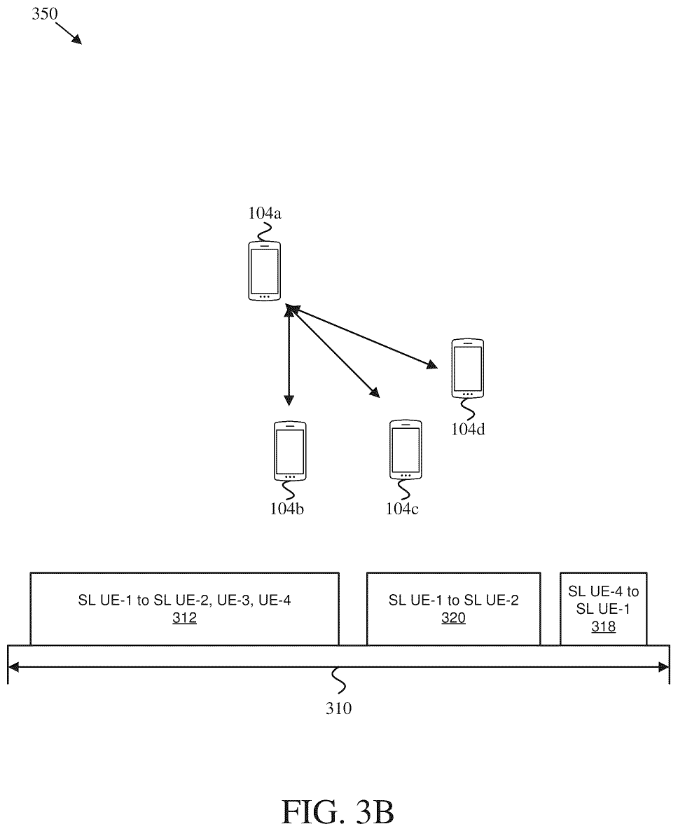

According to one aspect of the disclosure, an initiating UE may cooperatively share the remaining COT resources with a plurality of UE(s) or destinations using a COT sharing indicator. In the illustrative embodiments of FIGS. 2A-2B and 3A-3B, etc., the initiating UE may share a remaining COT with UE-2, UE-3 and UE-4 in a FDM manner by allocating/mapping each of the receiver UE(s) or second UEs in each interlacing/sub-channel configuration. As one additional aspect, the initiating UE may also indicate the type of LBT to be performed by the second UE receiving the COT sharing indicator, which may include No-LBT (no sensing), Cat 2 LBT, Cat 4 LBT, or other defined LBT category.

FIG. 2A illustrates a system 200 by which sidelink channel occupancy time sharing between user equipments is indicated by group-casting of a COT indicator, which includes an LBT type indication, in accordance with aspects of the present disclosure. The system 200 may be implemented within and is described using components of the wireless communications system 100 of FIG. 1. The system 200 includes the UE 104a of FIG. 1 operating and referred to as an initiating UE because UE 104a initiates COT sharing with one or more other UEs, also referred to as second UEs. The initiating UE 104a acquires a COT (e.g., in an unlicensed spectrum), such as from a base station 102. After performing Cat 4 LBT, the initiating UE 104a, performs COT sharing by transmitting one or more COT sharing indicators to one or more second UEs. In the illustrated example of system 200, the initiating UE 104a transmits a COT sharing indicator 204 to three second UEs 104b, 104c, and 104d. Although three second UEs are illustrated in the system 200, it is appreciated that the COT sharing indicator 204 may be transmitted to any number of second UEs.

The COT sharing indicator 204 may be transmitted by the initiating UE 104a in any of a variety of different manners, such as transmitted in at least one cast type signaling (e.g., groupcast or broadcast) while scheduling PSSCH with similar cast type. Accordingly, the content of the new COT sharing indicator 204 may also include fields from SCI format 2A or 2B or 2C.

As illustrated in system 200, initiating UE 104a transmits the same COT sharing indicator 204 to each of the second UEs 104b, 104c, and 104d. In contrast, system 210 of FIG. 2B illustrates initiating UE 104a transmitting a separate COT sharing indicator 212, 214 or 216 to each of the second UEs 104b, 104c, or 104d. Specifically, FIG. 2B illustrates the transmission of the multiple different COT sharing indicators 212, 214, and 216 to respective ones of second UEs 104b, 104c, and 104d. The individual transmissions of COT sharing indicators 212, 214, and 216 provides an example of a unicast transmission. According to one aspect of the disclosure, the COT sharing indicators 212, 214, and 216 can each include a corresponding LBT type, from among multiple available LBT types that can be selected by the initiating UE 104a. According to one aspect, the LBT types corresponding to COT sharing indicators 212, 214, and 216 are different from each other. However, according to another aspect, the LBT types corresponding to COT sharing indicators 212, 214, and 216 are all the same.

The COT sharing indicator 204 or 212/214/216 is included in one or more of a set of SL occasions, which refer to times or locations where the COT sharing indicator 204 (if being transmitted) is expected to be received by the second UEs 104b, 104c, or 104d. These SL occasions may be, for example, the physical sidelink control channel (PSCCH) in each time slot of each subchannel of the physical sidelink shared channel (PSSCH).

In one or more implementations, the initiating UE 104a notifies the second UEs 104b, 104c, or 104d of a remaining duration of the COT that is being shared. The second UEs 104b, 104c, or 104d can then use at least part of the remaining CO duration to transmit control or data information, or a combination thereof, to the initiating UE 104a, to another UE (e.g., another one of the second UEs 104b, 104c, or 104d), and so forth.

According to one or more aspects of the present disclosure, the COT sharing indicator 204 or 212/214/216 includes a value for a selected LBT type from among multiple LBT types for channel sensing. A selected LBT type signals to a second device receiving the COT sharing indicator which LBT procedure to utilize before accessing resources identified by the sidelink channel occupancy sharing indicator. In an implementation in which second UEs 104b, 104c, and 104d all receive, via groupcast or broadcast, a same COT sharing indicator, such as COT sharing indicator 204 (FIG. 1), a second UE 104b, 104c, or 104d that has data to transmit is required to contend for the subchannel resources identified by the COT sharing indicator 204 before accessing the COT resources. In particular, in order to contend for access to the identified subchannel resources, a second UE has to perform a channel sensing procedure of a category identified by a channel sensing type value provided within the COT sharing indicator 204. For example, COT sharing indicator 204 may include a value that identifies an LBT Cat-2 procedure. A second UE 104b, 104c, or 104d is able to successfully perform a specified LBT procedure by detecting idle channel resources. In response to successfully performing the LBT procedure having a category corresponding to the received LBT type, the second UE 104b, 104c, or 104d is able to access the resources to transmit data.

Additionally or alternatively, the initiating UE 104a can initiate COT sharing based on Cat 4 LBT, and maximum COT (MCOT) of the initiating UE 104a is spread across multiple time domain and frequency domain resource pool(s) within the LBT subband for which the Cat 4 was successful. In such situations, the initiating UE 104a may include the resource pool ID(s) as part of the COT sharing indicator 204. As presented herein, the MCOT is a maximum COT duration of a channel occupancy, counted or measured from the first transmission after initiation of the COT.

Referring again to FIG. 2B, in one or more implementations, the initiating UE 104a may separately transmit, via unicast, multiple (‘N’) COT sharing indicators 212, 214 and 216 each intended for a respective destination ID with which the initiating UE 104a would like to COT share. Such COT sharing indicators 212, 214 and 216 may mention remaining CO duration from a MCOT or may use a UE specific time offset (or destination ID specific offset) for starting the UE specific CO duration (or destination ID specific duration). According to one or more aspects of the present disclosure, COT sharing indicators 212, 214 and 216 identify different sets of subchannel resources from within the COT. Each COT sharing indicator 212, 214 and 216 can be configured, in a manner similar to the COT sharing indicator 204 (FIG. 2A), to provide values for various parameters related to attributes of associated resources.

In one or more implementations, the initiating UE 104a transmits the COT sharing indicator 204 or 212, 214 and 216 in multiple parts, such as a first part indicating the intention of the initiating UE 104a to share the COT, followed by a second part to trigger the start of sharing the remaining CO duration.

Each of the COT sharing indicators 212, 214, and 216 is included in one or more of a set of SL occasions, which refer to times or locations where the COT sharing indicators 212, 214 and 216 (if being transmitted) are expected to be respectively received by the second UEs 104b, 104c, and 104d. These SL occasions may be, for example, the physical sidelink control channel (PSCCH) in each time slot of each respective subchannel of the physical sidelink shared channel (PSSCH).

In an implementation in which second UEs 104b, 104c, and 104d all receive, via unicast, N distinct COT sharing indicators, such as COT sharing indicators 212, 214 and 216, a second UE 104b, 104c, and/or 104d that has data to transmit may not be required to contend for the subchannel resources identified by the respective COT sharing indicator before accessing the COT resources. In particular, each second UE may receive a No-LBT channel sensing type indicating that an LBT procedure should not be performed before accessing subchannel resources identified by the respective COT sharing indicator 212, 214 or 216.

FIG. 3A is a schematic block diagram 300 illustrating one embodiment of SL UE initiated COT sharing, according to one aspect of the disclosure. The diagram 300 illustrates a SL communication system including an initiating UE-1 104a, and three second UEs 104b, 104c, and 104d. For the description, the three second UEs are also referred to as UE-2 104b, UE-3 104c, and UE-4 104d, with the initiating UE-1 104a being a first UE in the sequence. The UE-1 104a establishes a COT 310 that has a corresponding CO duration and resources. According to one or more aspects, the UE-1 104a performs LBT Cat 4 (CCA) to acquire a channel for sidelink transmission, and the UE-1 104a may initiate SL COT sharing with other SL UEs for performing sidelink transmission. The UE-1 104a transmits via SL a UE-initiated COT sharing message/indication 312 with each of the UE-2 104b, the UE-3 104c, and the UE-4 104d. The SL UE-initiated COT sharing message (312) may include a broadcast or a separate unicast SL UE-1 to SL UE-2, UE-3, UE-4 transmission and includes an LBT type. Each of the second UEs contend for and transmit data on available COT resources of the COT 310, based on the received LBT type. In FIG. 3A, UE-2 transmits to UE-1 via first SL transmission 314, UE-3 transmits to UE-1 via second SL transmission 316, and UE-4 transmits to UE-1 via first SL transmission 318, using separate non-overlapping portions of the available COT resources of the COT 310.

According to one or more aspects, initiating UE 104a may share device-specific subchannel resources from a remaining COT with UE-2, UE-3 and UE-4 in a frequency division multiplexing (FDM) manner by allocating/mapping each of the second UE(s) in each interlacing/sub-channel configuration and by indicating the type of LBT (e.g., No-LBT) to be performed by a second UE receiving a COT sharing indicator.

The COT sharing indicator 312 may be transmitted using any of a variety of types of control signaling, such as at least one of Radio Resource Control (RRC), Sidelink Control Information (SCI), Medium Access Control (MAC) Control Element (CE), or the like. Similarly, other control signaling between two or more of the UEs may also be transmitted using any of a variety of types of control signaling, such as at least one of RRC, SCI, MAC CE, or the like. In one or more implementations, the COT sharing indicator 312 is transmitted using SCI and additional information, such as one or more destination IDs, a time offset, etc., using a different type of control signaling (e.g., MAC CE). In this situation, the MAC CE (or other type of control signaling) and the SCI may be transmitted together in the same slot.

In one or more embodiments, the COT sharing indicator 312 may include an SCI field that may indicate a multiple access mode for a respective second UE to utilize in order to transmit data. In particular, the SCI may indicate that a second UE transmit data using one of frequency division multiplexing (FDM), time division multiplexing (TDM) and a combination of FDM and TDM. According to an aspect, initiating UE 104a may transmit ‘N’ COT sharing SCIs separately to second UEs at a respective destination ID(s) using a UE-specific interlacing subchannel index or destination ID-specific interlacing subchannel index. In addition, the initiating UE 104a may provide a UE-specific or destination ID-specific duration for using assigned subchannel resources based on a remaining channel occupancy duration.

In one or more implementations, the COT sharing indicator 312 may include a remaining CO duration (e.g., in terms of time slots or time units, such as in milliseconds). The remaining CO duration is, for example, the duration of the COT that the initiating UE 104a is not using for SL transmission to one of the second UEs 104b, 104c, or 104d).

Additionally or alternatively, the COT sharing indicator 312 includes a priority for the COT being shared (e.g., the Channel Access Priority Class (CAPC) value for the COT being shared). This allows information regarding the COT to be shared, which allows different COTs to be given priority over other COTs based on the priority value, etc.

Additionally or alternatively, the COT sharing indicator 312 includes one or more destination ID(s) for sharing the remaining CO duration. The one or more destination ID(s) identify the entities (e.g., second UEs) that are able to use the shared COT. The entities identified by the one or more destination ID(s) may be UEs, users or user accounts, applications, etc.

Additionally or alternatively, the COT sharing indicator 312 includes a time slot offset or symbol offset indicating when the COT sharing indicator may be transmitted and remaining CO duration may be utilized by a second UE for transmission by the second UE beginning from the reception of the COT sharing indicator 312.

Additionally or alternatively, the COT sharing indicator 312 includes one or more resource pool IDs or a bitmap containing multiple resource pool IDs that identify one or more resources being shared as part of the COT sharing.

In one or more implementations, the initiating UE 104a transmits (e.g., in the COT sharing indicator 312) a COT sharing SCI ‘X’ time offset so that a second UE 104b, 104c, or 104d that receives the COT sharing SCI ‘X’ time offset has sufficient processing time to start its transmission (e.g., PSSCH/PSCCH/PSFCH) in the remaining CO duration. The COT sharing SCI may indicate a time slot offset or a symbol offset (X). The remaining CO duration may be defined, for example, in a number of slots, starting from the slot where the second UE 104b, 104c, or 104d detects the COT sharing SCI. The remaining CO duration may be defined, for example, in terms of physical slot duration.

Referring now to FIG. 3B, there is illustrated a schematic block diagram 350 illustrating one embodiment of SL UE initiated COT sharing, where a second UE does not utilize the allocated COT resources, according to one aspect of the disclosure. The components and features that are similar to FIG. 3A are not described within the FIG. 3B description.

According to this aspect, after sharing the COT with the second UEs, the initiating UE 104a may continue to transmit in the remaining CO duration, while still sharing its CO duration with other UEs. As illustrated by SL UE1-SL UE2 transmission 320, according to one or more aspects of the disclosure, the initiating UE 104a may continue to transmit in the remaining CO duration while sharing the CO duration with one or more second UEs 104b, 104c and/or 104d. According to one or more embodiments, the initiating UE 104a shares a remaining channel occupancy duration with at least one second UE (104b) of which initiating UE 104a does not know a buffer status. If a second UE 104b does not have any data after receiving a COT sharing indicator, it may be likely that the second device may not transmit any data in the remaining channel occupancy duration. However, the initiating UE 104a may monitor for any lack of transmission (i.e., to sense idle transmission slots) from the second UE 104b with whom the initiating device has shared the COT. The initiating UE 104a may monitor transmission slots for a certain preset duration and may start transmission in the remaining channel occupancy duration if the slots are idle and if there is buffered data for the initiating UE 104a to transmit. According to one embodiment, the initiating UE may perform Cat 2 LBT if the preset duration for monitoring transmission slots is greater than a pre-configured threshold value in terms of units of time (e.g., milliseconds), number of slots or number of symbols. The initiating UE 104a thus recaptures the remaining duration (Tgap) of the COT that was shared with the second UE 104b, and the initiating UE may start transmission in the remaining CO duration after performing Cat 2 LBT.

According to an aspect, the initiating UE 104a transmits a COT sharing indicator by sending sidelink control information (SCI) to physical resource blocks (PRBs) in each subchannel of a plurality of subchannels, the SCI indicating a multiple access mode. In addition, the initiating UE 104a transmits a device specific resource access duration value in a message addressed to each respective destination ID. A second UE that receives the SCI via a PRB(s) in a subchannel can initiate data transmission within a subchannel in which the SCI is received.

In another implementation, an alternative sharing indicator to the COT sharing indicator is used for the purpose of cooperative channel occupancy time sharing. The alternative sharing indicator can be configured to transmit a clear-to-send indication/message to a plurality of second UEs in a defined vicinity of an initiating UE and/or other second UEs. The alternative sharing indicator can indicate a remaining channel occupancy duration based on FDM resource access. Additionally, the alternative sharing indicator may indicate that an LBT should not be performed in order to transmit data.

According to one or more aspects, one or more second UEs may be pre-configured as recipients of reserved radio resources as a result of a configured grant (CG). The reserved resources may be configured with corresponding interlacing channel indices. The initiating UE may send interlacing channel/sub-channel indices via the received sidelink channel occupancy sharing indicator to a second device having CG resources, as well as an SCI. The second device can decode the received SCI to determine a multiple access mode. In addition, the second device can determine whether to activate the reserved radio resources. In response to determining that the reserved radio resources are to be activated, the second device can transmit data, based on the decoded SCI, by accessing, using the interlacing channel or sub-channel index, sidelink sub-channel resources to activate the reserved radio resources.

According to one or more embodiments, second UEs, after receiving the COT sharing indicator, may respond with a feedback message to notify the initiating UE whether the second UE intends to perform transmission in the remaining channel duration. The feedback message enables the initiating UE to manage the remaining CO duration and to minimize having transmission slots remain empty. In one implementation, the feedback message is transmitted using a PSFCH resource and may contain positive acknowledgment, or a negative acknowledgment of a second UE's intention to transmit data.

In another implementation, a second UE may transmit a feedback message using a SCI indicating the reservation of resources for performing transmission within the remaining channel occupancy. In another implementation, the feedback message may contain additional information such as the type of transmission to be performed in the shared COT. According to an aspect, the feedback message can be provided via PSFCH, PSSCH/PSCCH, etc. The additional information of the feedback message can include a transmission duration in terms of a number of slots to be used.

According to one aspect of the disclosure, the initiating UE 104a may enable a second UE that receives a COT indicator to transmit data without having to perform a LBT or other type of channel sensing procedure. In an implementation in which second UEs 104b, 104c, and 104d each receive, via unicast, N (e.g., 3) distinct COT sharing indicators, such as COT sharing indicators 212, 214 and 216 (FIG. 2B), a second UE 104b, 104c, and 104d that has data to transmit may not be required to contend for the subchannel resources identified by the respective COT sharing indicator before accessing the COT resources. In particular, one or more second UE may receive a No-LBT channel sensing type indicating that an LBT procedure should not be performed before accessing subchannel resources identified by the respective COT sharing indicator 212, 214 or 216 (FIG. 2B).

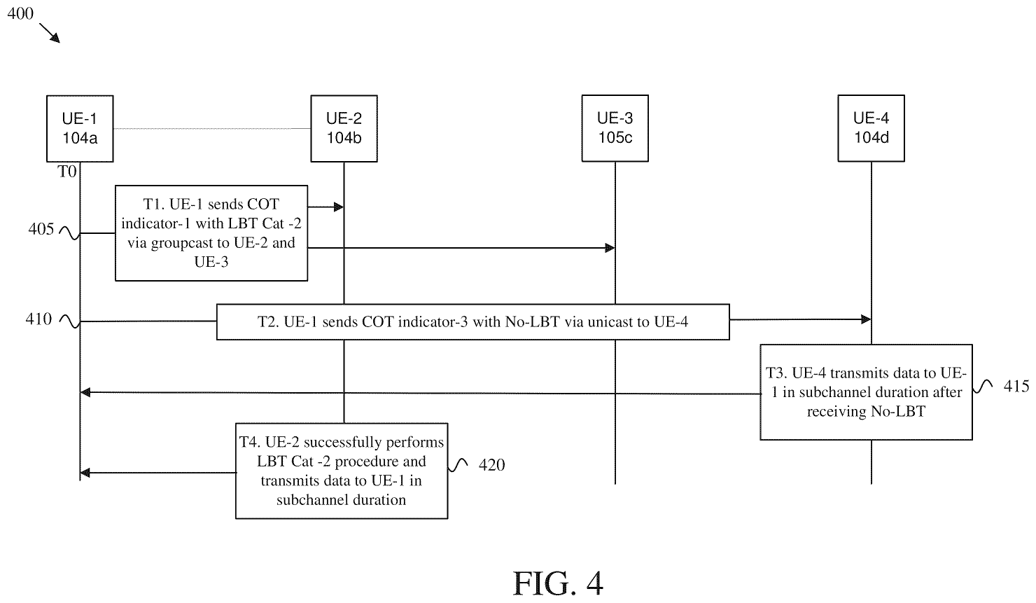

FIG. 4 is a signal flow timing diagram illustrating one embodiment of a procedure for UE-initiated COT sharing with unique LBT types in accordance with aspects of the present disclosure. In signal flow diagram 400, messages are transmitted between an initiating UE (e.g., UE-1 104a) and second UEs (e.g., UE-2, UE-3, UE-4, 104b-104d). Arrows indicate the directional flow of each transmission, with time increasing vertically downwards from T0, T1, T2, etc. At time T0, UE-1 104a acquires a COT. At time T1, UE-1 104a initiates a sharing procedure with second UEs by sending a first COT indicator message (e.g., COT indicator-1) 405 via groupcast to UE-2 104b and UE-3 104c. The first COT indicator message 405 includes a channel sensing value for an LBT type. In the example illustration of FIG. 4, the channel sensing value indicates LBT CAT-2.

At time T2, UE-1 104a sends a COT indicator message (e.g., COT indicator-3) 410 via unicast to UE-4 104d. As illustrated, the second COT indicator message 410 includes a channel sensing value corresponding to No-LBT as the LBT type.

At time T3, UE-4 104d transmits data via message 415 to UE-1 104a using sub-channel resources identified by COT indicator-3. UE-4 104d sends message 415 by transmitting data within a corresponding duration of the identified subchannel resources and satisfies the NO-LBT indicator request by not performing an LBT procedure.

At time T4, UE-2 104b successfully completes performance of the LBT CAT-2 procedure and begins transmitting data via message 420 to UE-1 104a using sub-channel resources identified by COT indicator-1. UE-2 104b sends message 420 by transmitting data within a corresponding duration of the identified subchannel resources after satisfying the LBT CAT-2 indicator request by successfully performing an LBT CAT-2 procedure.

By successfully contending for the sub-channel resources identified by COT indicator-1 against UE-3 104c, UE-2 104-b wins the right to access the identified sub-channel resources to transmit data at time T4.

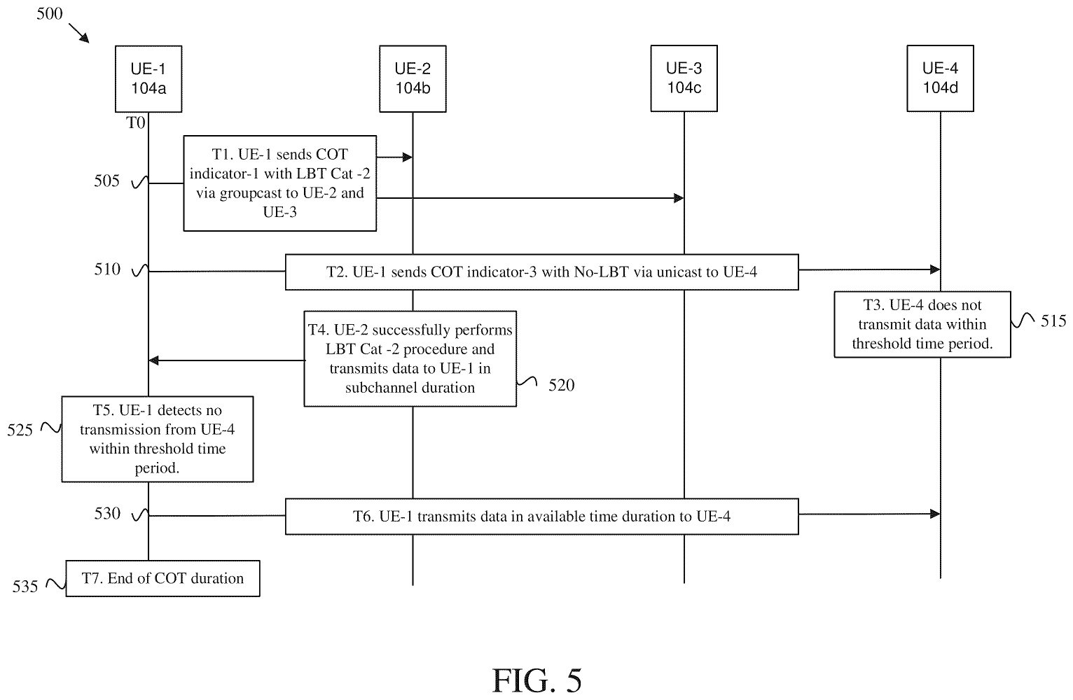

FIG. 5 is a signal flow timing diagram illustrating another embodiment of a procedure for UE-initiated COT sharing showing an originating UE's use of remaining resources of previously assigned COT resources, in accordance with aspects of the present disclosure. In signal flow diagram 500, messages are transmitted between an initiating UE (e.g., UE-1 104a) and other/second UEs (e.g., UE-2, UE-3, UE-4). Arrows indicate the directional flow of each transmission. At time T1, UE-1 104a initiates a sharing procedure with second UEs by sending a first COT indicator message (e.g., COT indicator-1) 505 via groupcast to UE-2 104b and UE-3 104c. The first COT indicator message 505 includes a channel sensing value for an LBT type. In the example illustration of FIG. 5, the channel sensing value indicates LBT CAT-2.

At time T2, UE-1 104a sends a COT indicator message (e.g., COT indicator-3) 510 via unicast to UE-4 104d. As illustrated, the second COT indicator message 510 includes a channel sensing value corresponding to No-LBT. According to an aspect, the COT indicator-3 transmitted by UE-1 104a to UE-4 104d includes an offset period by which time UE-4 104d is expected to transmit data. However, at time T3, UE-4 104d does not transmit data within the preset/threshold time period, as illustrated by status 515.

At time T4, UE-2 104b successfully completes performance of the LBT CAT-2 procedure and begins transmitting data via message 520 to UE-1 104a using sub-channel resources identified by COT indicator-1. UE-2 104b sends message 520 by transmitting data within a corresponding duration of the identified subchannel resources after satisfying the LBT CAT-2 indicator request by successfully performing an LBT CAT-2 procedure. By successfully contending for the sub-channel resources identified by COT indicator-1 against UE-3 104c, UE-2 104-b wins the right to access the identified sub-channel resources to transmit data.

At time T5, UE-1 104a detects that there is no transmission within the assigned subchannel resources within a threshold time period by UE-4 104d, as illustrated by status 525. Thus, at time T6, UE-1 104a utilizes remaining resources of the previously assigned subchannel resources to transmit data via message 530 to UE-4 104d in a remaining time duration. At time T7, the COT duration ends, as illustrated by status 535.

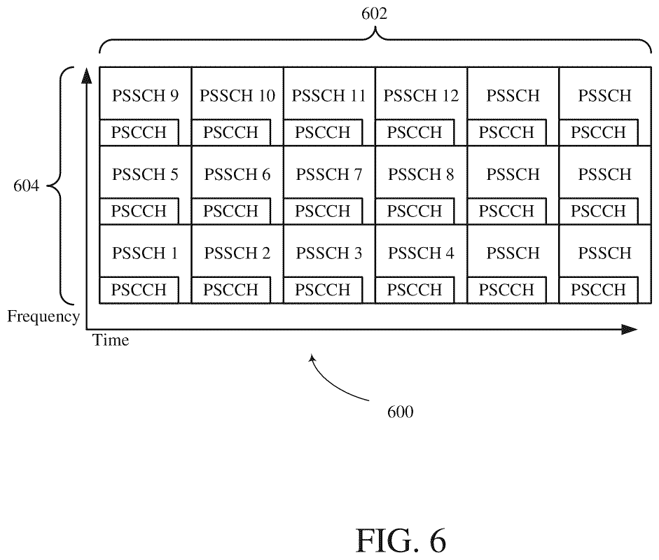

FIG. 6 illustrates an example 600 of subchannels by which an initiating UE provides a COT sharing indicator to a second device. The example 600 shows multiple (e.g., six as illustrated) time slots 602 in each of multiple (e.g., three as illustrated) different subchannels 604. The COT sharing indicator 204 is included in the PSCCH in a time slot 602 of each subchannel 604. The second UEs 104b, 104c, or 104d monitor this PSCCH, which may be referred to as SL occasions, in order to receive the COT sharing indicator 204, and the associated a value for an LBT type of channel sensing.

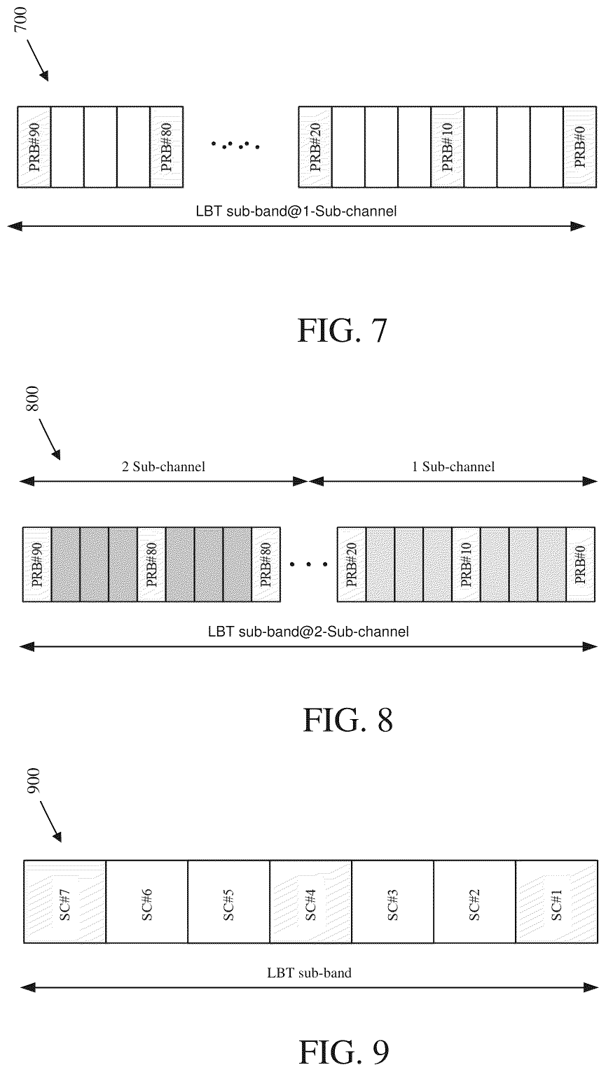

FIGS. 7, 8, and 9 provide solutions for sidelink operation over the unlicensed spectrum that meets regulatory requirements, e.g., of Power Spectrum Density (“PSD”) and the minimum channel occupancy (80%) regulations. In various embodiments, the UE is configured with a resource pool interlacing scheme to occupy minimum occupied bandwidth, minimum subchannel size(s) allocation to a UE for transmission could cover the minimum occupied bandwidth, subchannel wise interlacing and doing both subchannel and resource pool wise interlacing, restriction on configuring interlacing, especially considering larger subcarrier spacing (“SCS”) values and larger subchannel sizes.

According to one or more aspects of the present disclosure, each sidelink resource pool is configured to occupy the minimum occupied bandwidth (e.g., 20 MHz BW) using an interlacing configuration. The number of frequency resources (i.e., subchannels or PRBs) per interlace is represented by N, and the spacing between interlace is represented by M, where the values of M and N are configured per resource pool based on the configured subchannel size. In certain embodiments, the interlacing itself is implemented on a subchannel-wise basis.

According to one or more aspects of the present disclosure, when more than one resource pool is configured to occupy the minimum occupied bandwidth (for e.g., 20 MHz), then the number of resource pool occupying the LBT subband of 20 MHz bandwidth could be interleaved such that each interleaved resource pool occupies the entire LBT subband. According to an aspect, the sidelink subchannel may be defined using non-contiguous frequency resources based on an interleaving of PRBs (or PRB groups) within a resource pool, thereby spreading the subchannel across a resource pool (in frequency domain).

FIG. 7 depicts an example interlacing structure design 700 with PRB-level interlacing across a subchannel, according to embodiments of the disclosure. According to one or more aspects, when there is only one subchannel within the LBT subband, then the interlacing is performed within that subchannel. It is assumed that the LBT subband spans 100 PRBs (i.e., from PRB index #0 to PRB index #99) with SCS=15 kHz. As depicted, the interlacing structure comprises one PRB in ten, for example PRBs #0, #10, #20, #30, #40, #50, #60, #70, #80, and #90. For the depicted example, N′=10, M′=10, and the starting PRB index =0.

FIG. 8 depicts another example interlacing structure design 800 with PRB-level interlacing across a subchannel, according to embodiments of the disclosure. According to one or more aspects, when there are more than one subchannels within the LBT subband, then the interlacing is performed across more than one subchannels to satisfy the minimum occupied bandwidth criteria. It is assumed that the LBT subband spans 100 PRBs (i.e., from PRB index #0 to PRB index #99) with SCS=15 kHz. Here, the first subchannel comprises at least PRB index #0 to PRB index #20 and the second subchannel comprises at least PRB index #80 to PRB index #99. In one embodiment, the first and second subchannels are of equal size. In another embodiment, the first and second subchannels are of different sizes.

FIG. 9 depicts another example interlacing structure design 900 with subchannel-level interlacing across a resource pool, according to embodiments of the disclosure. Here, it is assumed that the resource pool is comprises of at least seven subchannels. The subchannels may be of equal size or may be of different sizes, e.g., according to the principles described below. As depicted, the interlacing structure comprises the lowest subchannel index (e.g., SC #1), the highest subchannel index (e.g., SC #7), and at least one subchannel in the middle of the resource pool (e.g., SC #4).

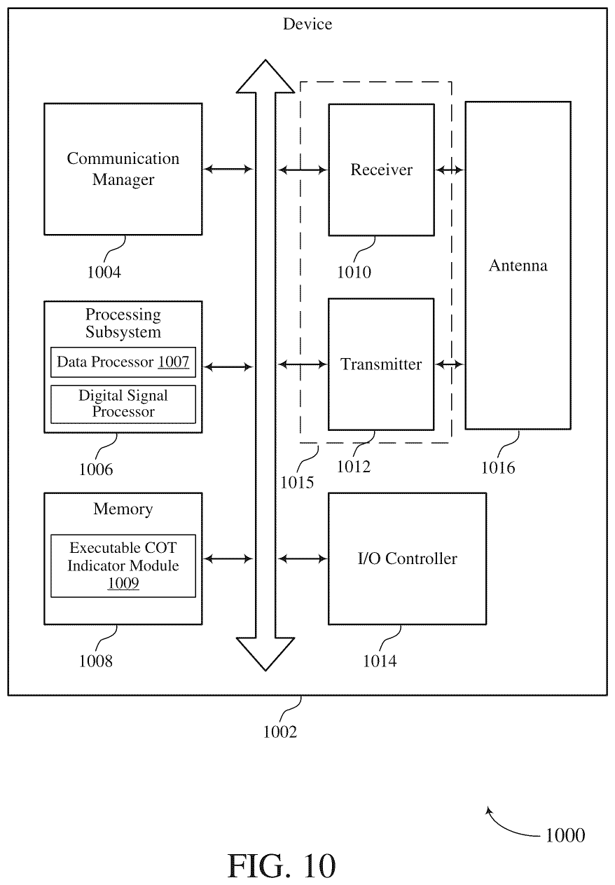

FIG. 10 illustrates an example of a block diagram 1000 of a device 1002 that supports initiating sidelink channel occupancy time sharing, with LBT type selection in accordance with aspects of the present disclosure. The device 1002 may be an example of a UE 104, as described herein. The device 1002 may support wireless communication with one or more base stations 102, UEs 104, or any combination thereof. The device 1002 may include components for bi-directional communications including components for transmitting and receiving communications, such as a communications manager M04, a processor 1006, a memory 1008, a receiver 1010, transmitter 1012, and an I/O controller 1014. These components may be in electronic communication or otherwise coupled (e.g., operatively, communicatively, functionally, electronically, electrically) via one or more interfaces (e.g., buses).

The communications manager 1004, the receiver 1010, the transmitter 1012, or various combinations thereof or various components thereof may be examples of means for performing various aspects of the present disclosure as described herein. For example, the communications manager 1004, the receiver 1010, the transmitter 1012, or various combinations or components thereof may support a method for performing one or more of the functions described herein.

In some implementations, the communications manager 1004, the receiver 1010, the transmitter 1012, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 1006 and the memory 1008 coupled with the processor 1006 may be configured to perform one or more of the functions described herein (e.g., by executing, by the processor 1006, instructions stored in the memory M08).

Additionally or alternatively, in some implementations, the communications manager 1004, the receiver 1010, the transmitter 1012, or various combinations or components thereof may be implemented in code (e.g., as communications management software or firmware) executed by the processor 1006. If implemented in code executed by the processor 1006, the functions of the communications manager 1004, the receiver 1010, the transmitter 1012, or various combinations or components thereof may be performed by a general-purpose processor 1007, a DSP, a central processing unit (CPU), an ASIC, an FPGA, or any combination of these or other programmable logic devices (e.g., configured as or otherwise supporting a means for performing the functions described in the present disclosure).

In some implementations, the communications manager 1004 may be configured to perform various operations (e.g., receiving, monitoring, transmitting) using or otherwise in cooperation with the receiver 1010, the transmitter 1012, or both. For example, the communications manager 1004 may receive information from the receiver 1010, send information to the transmitter 1012, or be integrated in combination with the receiver 1010, the transmitter 1012, or both to receive information, transmit information, or perform various other operations as described herein. Although the communications manager 1004 is illustrated as a separate component, in some implementations, one or more functions described with reference to the communications manager 1004 may be supported by or performed by the processor 1006, the memory 1008, or any combination thereof. For example, the memory 1008 may store code, which may include instructions executable by the processor 1006 to cause the device 1002 to perform various aspects of the present disclosure as described herein, or the processor 1006 and the memory 1008 may be otherwise configured to perform or support such operations.

For example, the communications manager 1004 may support wireless communication at a first device (e.g., the device 1002) in accordance with examples as disclosed herein. The communications manager 1004 may be configured to or may configure the device 1002 to transmit, via the transceiver 1015, a sidelink channel occupancy sharing indicator that enables at least two devices to transmit data utilizing available sidelink channel resources within a channel occupancy duration, the sidelink channel occupancy sharing indicator comprising a selected listen before talk (LBT) type for channel sensing from among multiple LBT types which signal to a second device receiving the sidelink channel occupancy sharing indicator which LBT procedure to utilize before accessing resources identified by the sidelink channel occupancy sharing indicator. The communications manager 1004 may be further configured to or may further configure the device 1002 to allocate the available sidelink channel resources to the at least two devices to enable multiple devices to cooperatively share available sidelink channel resources with non-overlapping time or frequency domain usage in order to achieve a channel occupancy threshold level of resource utilization in an unlicensed spectrum.

Alternatively, when the device 1002 is a second or receiving device, communications manager 1004 may be configured to or may configure the device 1002 to receive, from the sidelink sharing device via the transceiver 1015, a sidelink channel occupancy sharing indicator that identifies, from among available sidelink channel resources, specific sidelink channel resources that the device can utilize to transmit data and includes a listen before talk (LBT) type of channel sensing from among multiple LBT types indicating which LBT procedure to utilize before the device initiates transmitting over the sidelink channel resources. The communications manager 1004 may be further configured to or may further configure the device 1002 to determine whether the device is able to utilize the identified sidelink channel resources to transmit data and transmit the data over the sidelink channel resources in accordance with the LBT procedure, in response to the device being able to utilize the sidelink channel resources.

The processor 1006 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 1006 may be configured to operate a memory array using a memory controller. In some other implementations, a memory controller may be integrated into the processor 1006. The processor 1006 may be configured to execute computer-readable instructions stored in a memory (e.g., the memory 1008) to cause the device 1002 to perform various functions of the present disclosure. According to an aspect, these instructions include executable COT indicator module 1009 which when executed enables the device 1002 to support UE initiated sidelink channel occupancy time sharing between UEs based on LBT types.

The memory 1008 may include random access memory (RAM) and read-only memory (ROM). The memory 1008 may store computer-readable, computer-executable code including instructions that, when executed by the processor 1006 cause the device 1002 to perform various functions described herein. The code may be stored in a non-transitory computer-readable medium such as system memory or another type of memory. In some implementations, the code may not be directly executable by the processor M06 but may cause a computer (e.g., when compiled and executed) to perform functions described herein. In some implementations, the memory 1008 may include, among other things, a basic I/O system (BIOS) which may control basic hardware or software operation such as the interaction with peripheral components or devices.

The I/O controller 1014 may manage input and output signals for the device 1002. The I/O controller 1014 may also manage peripherals not integrated into the device 1002. In some implementations, the I/O controller 1014 may represent a physical connection or port to an external peripheral. In some implementations, the I/O controller 1014 may utilize an operating system such as iOS®, ANDROID®, MS-DOS®, MS-WINDOWS®, OS/2®, UNIX®, LINUX®, or another known operating system. In some implementations, the I/O controller 1014 may be implemented as part of a processor, such as the processor 1006. In some implementations, a user may interact with the device 1002 via the I/O controller 1014 or via hardware components controlled by the I/O controller 1014.

In some implementations, the device 1002 may include a single antenna 1016. However, in some other implementations, the device 1002 may have more than one antenna 1016, which may be capable of concurrently transmitting or receiving multiple wireless transmissions. The receiver 1010 and the transmitter 1012 may communicate bi-directionally, via the one or more antennas 1016, wired, or wireless links as described herein. For example, the receiver 1010 and the transmitter 1012 may represent a wireless transceiver 1015 and may communicate bi-directionally with another wireless transceiver. The transceiver 1015 may also include a modem to modulate the packets, to provide the modulated packets to one or more antennas 1016 for transmission, and to demodulate packets received from the one or more antennas 1016.

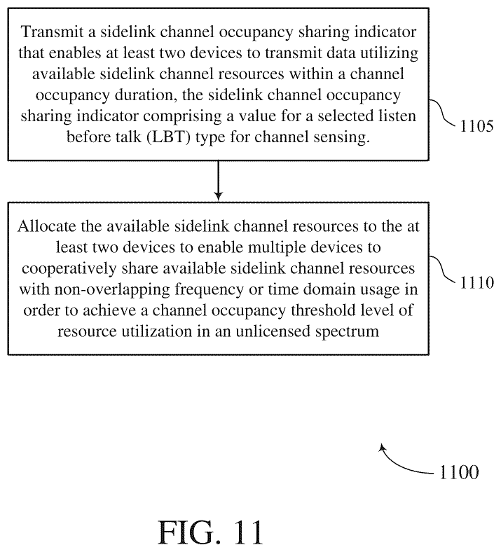

FIGS. 11-13 illustrates flowcharts of methods 1100, 1200, and 1300 that each supports different aspects of user equipment initiated sidelink channel occupancy time sharing between user equipment based on LBT type, in accordance with aspects of the present disclosure. The operations of the method 1100 may be implemented by a device or its components as described herein. For example, the operations of the different methods 1100, 1200, and 1300 may be performed by a UE 104 as described with reference to FIGS. 1 through 10. In some implementations, the device may execute a set of instructions to control the function elements of the device to perform the described functions. Additionally, or alternatively, the device may perform aspects of the described functions using special-purpose hardware.

Referring first to method 1100, at 1105, the method 1100 may include transmitting, via a transceiver, a sidelink channel occupancy sharing indicator that enables at least two devices to transmit data utilizing available sidelink channel resources within a channel occupancy duration, the sidelink channel occupancy sharing indicator comprising a value for a selected listen before talk (LBT) type from among multiple LBT types for channel sensing, which LBT type signals to a second device that receives the sidelink channel occupancy sharing indicator which LBT type to utilize before accessing resources identified by the sidelink channel occupancy sharing indicator. The operations of 1105 may be performed in accordance with examples as described herein. In some implementations, aspects of the operations of 1105 may be performed by a device as described with reference to FIG. 1.

At 1110, the method 1100 may include allocating the available sidelink channel resources to the at least two devices to enable multiple devices to cooperatively share available sidelink channel resources with non-overlapping frequency or time domain usage in order to achieve a channel occupancy threshold level of resource utilization in an unlicensed spectrum. The operations of 1110 may be performed in accordance with examples as described herein. In some implementations, aspects of the operations of 1110 may be performed by a device as described with reference to FIG. 1.

According to one or more embodiments, the multiple LBT types comprise a first LBT type of No-LBT. The multiple LBT types further include a Cat 2 LBT based on an energy sensing procedure and a Cat 4 LBT based on a clear channel assessment procedure.

According to one or more embodiments, the allocating further includes assigning channel resources to a second device that is provided the No-LBT within the sidelink channel occupancy sharing indicator and scheduling an assignment of channel resources to another second device that is provided one of the Cat 2 LBT and the Cat 4 LBT, the channel resources assigned, after the second device successfully completes an LBT procedure of an assigned category of LBT.

In one embodiment, the available sidelink channel resources are an available channel occupancy time (COT) which includes one or more of frequency domain resources and time domain resources. Additionally, in one or more embodiments, the method further includes: transmitting, within the sidelink channel occupancy sharing indicator, an indication that COT sharing is to be performed in one of a frequency division multiplexing (FDM), time division multiplexing (TDM), and a combination of FDM and TDM; and assigning the available COT to the at least two second devices by mapping each second device via one of a device ID and a resource index to respectively selected COT sub-channel resources in accordance with an interlacing configuration. The interlacing configuration enables at least one second device to utilize the first COT sub-channel resources via a multiple access protocol while at least one other device from among the device and one of the at least two second devices utilizes second COT sub-channel resources.

According to one or more embodiments, transmitting further includes sending the sidelink sharing information as at least one of: device specific messages having sidelink control information (SCI) to indicate a multiple access mode to each of the at least two second devices, each message being addressed to one or more of a destination identification (ID) of a respective second device and a cast type of a respective second device; a broadcast message to the at least two second devices; and a multicast message to selected second devices among the at least two second devices, the multi-cast message having SCI to indicate a multiple access mode and addressed to each of the at least two second devices via a respective one of a destination ID and a cast type.

According to one or more embodiments, the method 1100 includes assigning the available sidelink channel resources by sending device specific messages using one or more of a device specific interlacing subchannel index and a destination ID specific interlacing subchannel index, along with a corresponding device or destination specific duration of assigned subchannel resources from among the available sidelink channel resources.

According to one or more embodiments, transmitting the sidelink sharing information further includes: transmitting to each of the at least two second devices: sidelink control information (SCI) to physical resource blocks (PRBs) in each subchannel of a plurality of subchannels, the SCI indicating a multiple access mode; and a device specific resource access duration value in a message addressed to each respective destination ID. The SCI and the duration value enables a second device to initiate data transmission within a subchannel in which the second device receives the SCI.

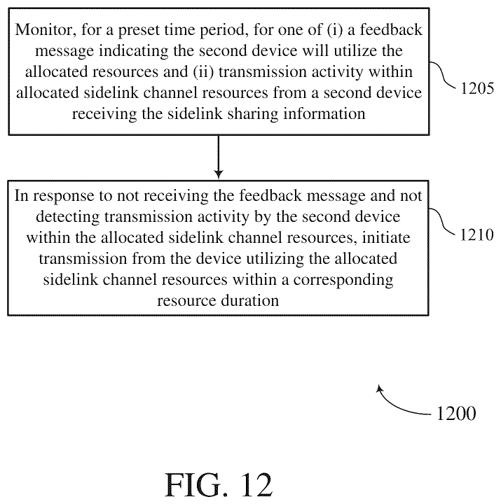

FIG. 12 illustrates one embodiment of an additional aspect of the disclosure, presented as method 1200. At 1205, the method 1200 may include monitoring, for a preset time period, for one of (i) a feedback message indicating the second device will utilize the allocated resources and (ii) transmission activity within allocated sidelink channel resources from a second device receiving the sidelink sharing information. The operations of 1205 may be performed in accordance with examples as described herein. In some implementations, aspects of the operations of 1205 may be performed by a device as described with reference to FIGS. 1 and 2.

At 1210, the method 1200 may include in response to not receiving the feedback message and not detecting transmission activity by the second device within the allocated sidelink channel resources, initiating transmission from the device utilizing the allocated sidelink channel resources within a corresponding resource duration. The operations of 1210 may be performed in accordance with examples as described herein. In some implementations, aspects of the operations of 1210 may be performed by a device as described with reference to FIGS. 1 and 2.

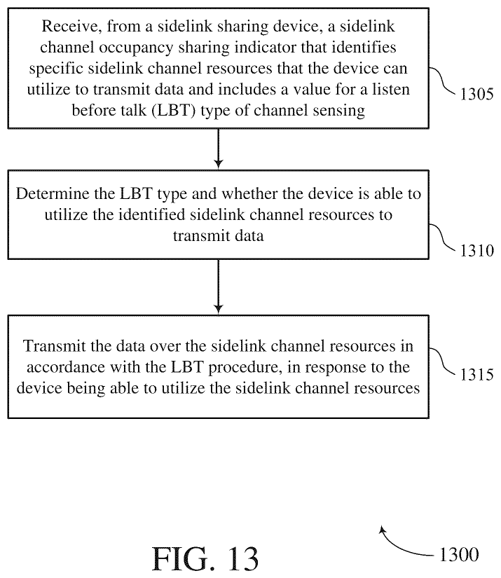

FIG. 13 illustrates method 1300 depicting one embodiment of an additional aspect of the disclosure, performed by the receiving device. At 1305, the method 1300 may include receiving, from a sidelink sharing device via the transceiver, a sidelink channel occupancy sharing indicator that identifies, from among available sidelink channel resources, specific sidelink channel resources that the device can utilize to transmit data and includes a value for a listen before talk (LBT) type of channel sensing from among multiple types indicating which LBT procedure to utilize before the device initiates transmitting over the sidelink channel resources. The operations of 1305 may be performed in accordance with examples as described herein. In some implementations, aspects of the operations of 1305 may be performed by a device as described with reference to FIGS. 1 and 2.

At 1310, the method 1300 may include determining the LBT type and whether the device is able to utilize the identified sidelink channel resources to transmit data. The operations of 1310 may be performed in accordance with examples as described herein. In some implementations, aspects of the operations of 1310 may be performed by a device as described with reference to FIGS. 1 and 2.

At 1315, the method 1300 may include transmitting the data over the sidelink channel resources in accordance with the LBT procedure, in response to the device being able to utilize the sidelink channel resources. The operations of 1315 may be performed in accordance with examples as described herein. In some implementations, aspects of the operations of 1315 may be performed by a device as described with reference to FIGS. 1 and 2.

According to one or more embodiments, method 1300 further includes in response to the LBT type being No-LBT, scheduling to transmit the data over the channel resources in accordance with a No-LBT procedure. According to one or more other embodiments, the method further includes, in response to the LBT type being one of a Cat 2 LBT and a Cat 4 LBT: performing an associated LBT procedure corresponding to a category indicated by the LBT type; and transmitting the data in accordance with the associated LBT procedure.

According to one or more embodiments, the method 1300 for receiving the sidelink channel occupancy sharing indicator includes receiving a channel occupancy time (COT) indicator and an SCI field that indicates a multiple access mode by which the device and at least one other device accesses channel resources. The multiple access mode is one of frequency division multiplexing (FDM), time division multiplexing (TDM), and a combination of FDM and TDM. The method further comprises accessing, using a resource index, respective sidelink sub-channel resources assigned in accordance with an interlacing configuration.

According to one or more embodiments, the method 1300 further includes receiving reserved radio resources as a result of a configured grant (CG), receiving an interlacing channel/sub-channel index via the received sidelink channel occupancy sharing indicator, decoding the received SCI to determine a multiple access mode, determining whether to activate the reserved radio resources; and in response to determining that the reserved radio resources are to be activated, transmitting data, based on the decoded SCI, by accessing, using the interlacing sub-channel index, sidelink sub-channel resources to activate the reserved radio resources.

According to one or more embodiments, the method 1300 further includes in response to receiving the sidelink channel occupancy sharing indicator, transmitting a feedback message indicating that the device intends to initiate data transmission using configured resources within a threshold time period.

It should be noted that the methods described herein describes possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor 1007, a DSP, an ASIC, a CPU, an FPGA or other programmable logic device, discrete gate or transistor logic, discrete hardware components, or any combination thereof designed to perform the functions described herein. A general-purpose processor 1007 may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.” Further, as used herein, including in the claims, a “set” may include one or more elements.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A User Equipment (UE) for wireless communication, the UE comprising:
at least one memory; and
at least one processor coupled to the at least one memory and configured to cause the UE to:
transmit a sidelink channel occupancy sharing indicator that enables at least two UEs to perform sideline communication utilizing available sidelink channel resources during a channel occupancy duration, the sidelink channel occupancy sharing indicator comprising a value for a selected Listen-Before-Talk (LBT) type for channel sensing; and
allocate the available sidelink channel resources to the at least two UEs to enable the at least two UEs to cooperatively share the available sidelink channel resources.

2. The UE of claim 1, wherein the selected LBT types comprise a first LBT type of No-LBT.

3. The UE of claim 2, wherein the selected LBT types comprises a Category 2 (Cat 2) LBT based on an energy sensing procedure or a Category 4 (Cat 4) LBT based on a clear channel assessment procedure.

4. The UE of claim 3, wherein to allocate the sidelink channel resources, the at least one processor is configured to cause the UE to:
assign channel resources to a second UE that is provided the No-LBT within the sidelink channel occupancy sharing indicator; and
schedule an assignment of channel resources to another second UE that is provided one of the Cat 2 LBT and the Cat 4 LBT, the channel resources assigned, after the second UE successfully completes the LBT procedure of an assigned category of LBT.

5. The UE of claim 1, wherein the at least two UEs include at least two second UEs.

6. The UE of claim 5, wherein the UE further performs said transmitting by sending at least one of:
device specific messages having sidelink control information (SCI) to indicate a multiple access mode to each of the at least two second UEs, each message being addressed to one or more of a destination identification (ID) of a respective second UE and a cast type of a respective second UE;
a broadcast message to the at least two second UEs; and
a multicast message to selected second UEs among the at least two second UEs, the multicast message having SCI to indicate a multiple access mode and addressed to each of the at least two second UEs via a respective one of a destination ID and a cast type.

7. The UE of claim 6, wherein the UE:
assigns the available sidelink channel resources by sending device specific messages using one or more of a device specific interlacing subchannel index and a destination ID specific interlacing subchannel index, along with a corresponding device or destination specific duration of assigned subchannel resources from among the available sidelink channel resources.

8. The UE of claim 6, wherein the UE transmits the sidelink channel occupancy sharing indicator by transmitting to each of the at least two second UEs:
sidelink control information (SCI) to physical resource blocks (PRBs) in each subchannel of a plurality of subchannels, the SCI indicating a multiple access mode; and
a device specific resource access duration value in a message addressed to each respective destination ID;
wherein a second UE initiates data transmission within a subchannel in which the SCI is received.

9. The UE of claim 5, wherein:
the available sidelink channel resources are an available channel occupancy time (COT) which includes one or more of frequency domain resources and time domain resources; and
the processor further configures the UE to:
transmit, within the sidelink channel occupancy sharing indicator, an indication that COT sharing is to be performed in one of a frequency division multiplexing (FDM), time division multiplexing (TDM), and a combination of FDM and TDM; and
assign the available COT to the at least two second UEs by mapping each second UE via one of a device ID and a resource index to respectively selected COT sub-channel resources in accordance with an interlacing configuration, wherein the interlacing configuration enables the at least one second UE to utilize first COT sub-channel resources via a multiple access protocol while at least one other UE from among the UE and one of the at least two second UEs utilizes second COT sub-channel resources.

10. The UE of claim 1, wherein the at least two UEs comprise the UE and at least one second UE, and the processor is further configured to cause the UE to:
monitor, for a preset time period, for one of (i) a feedback message indicating the at least one second UE will utilize the allocated resources and (ii) transmission activity within allocated sidelink channel resources from a second UE receiving the sidelink channel occupancy sharing indicator; and
in response to not receiving the feedback message and not detecting transmission activity by the at least one second UE within the allocated sidelink channel resources, initiate transmission from the UE utilizing the allocated sidelink channel resources within a corresponding resource duration.

11. A User Equipment (UE) for wireless communication, the UE comprising:
at least one memory; and
at least one processor coupled to the at least one memory and configured to cause the UE to:
receive, from a sidelink sharing UE, a sidelink channel occupancy sharing indicator that identifies, from among available sidelink channel resources, specific sidelink channel resources that the device UE can utilize to perform sidelink communication and includes a value for a Listen-Before-Talk (LBT) type for channel sensing;
determine whether the UE is able to utilize the identified sidelink channel resources to perform sidelink communication; and
perform sidelink communication over the sidelink channel resources in accordance with the LBT procedure, in response to the UE being able to utilize the sidelink channel resources.

12. The UE of claim 11, wherein the processor is further configured to cause the UE to:
in response to the LBT type being No-LBT, schedule to perform sidelink communication over the channel resources in accordance with a No-LBT procedure.

13. The UE of claim 12, wherein the processor is further configured to cause the UE to:
in response to the LBT type being one of a Category 2 (Cat 2) LBT or a Category 4 (Cat 4) LBT:
perform an associated LBT procedure corresponding to a category indicated by the LBT type; and
perform sidelink communication in accordance with the associated LBT procedure.

14. The UE of claim 11, wherein:
the UE receiving of the sidelink channel occupancy sharing indicator comprises receiving the sidelink channel occupancy sharing indicator via one of:
a device specific message having sidelink control information (SCI) that indicates a multiple access mode to be used to access sidelink channel resources, the message being addressed using one or more of a destination identification (ID) of the UE and a cast type of the UE;
a multicast message having sidelink control information (SCI) that indicates a multiple access mode to be used to access sidelink channel resources, the multicast message being addressed using one or more of a destination ID of the UE and a cast type of the UE; and
a broadcast message broadcasted by the sidelink sharing UE.

15. The UE of claim 14, wherein:
the received sidelink channel occupancy sharing indicator comprises a channel occupancy time (COT) indicator and an SCI field that indicates a multiple access mode by which the UE and at least one other UE accesses sidelink channel resources, wherein the multiple access mode is one of frequency division multiplexing (FDM), time division multiplexing (TDM), and a combination of FDM and TDM; and
the UE accesses, using a resource index, respective sidelink sub-channel resources assigned in accordance with an interlacing configuration.

16. The UE of claim 11, wherein the processor is further configured to cause the UE to:
receive reserved radio resources as a result of a configured grant (CG);
receive an interlacing channel or sub-channel index via the received sidelink channel occupancy sharing indicator;
decode a received SCI to determine a multiple access mode;
determine whether to activate the reserved radio resources; and
in response to determining that the reserved radio resources are to be activated, perform sidelink communication, based on the decoded SCI, by accessing, using the interlacing channel or sub-channel index, sidelink sub-channel resources to activate the reserved radio resources.

17. The UE of claim 11, wherein the processor is further configured to cause the UE to:
in response to receiving the sidelink channel occupancy sharing indicator, transmit a feedback message indicating that the UE intends to initiate sidelink communication using configured resources within a threshold time period.

18. A method for wireless communication by a UE, the method comprising:
transmitting a sidelink channel occupancy sharing indicator that enables at least two UEs to transmit data utilizing available sidelink channel resources within a channel occupancy duration, the sidelink channel occupancy sharing indicator comprising a value for a selected Listen Before Talk (LBT) type for channel sensing; and
allocating the available sidelink channel resources to the at least two UEs to enable the at least two UEs to cooperatively share the available sidelink channel resources.

19. The method of claim 18, wherein:
the multiple LBT types comprise a first LBT type of No-LBT, a Category 2 (Cat 2) LBT based on an energy sensing procedure, or a Category 4 (Cat 4) LBT based on a clear channel assessment procedure; and
said allocating further comprises:
assigning channel resources to a second UE that is provided the No-LBT within the sidelink channel occupancy sharing indicator; and
scheduling an assignment of channel resources to another second UE that is provided one of the Cat 2 LBT and the Cat 4 LBT, the channel resources assigned, after the second UE successfully completes an LBT procedure of an assigned category of LBT.

20. The method of claim 18, wherein:
the available sidelink channel resources are an available channel occupancy time (COT) which includes one or more of frequency domain resources and time domain resources; and
the method further comprising:
transmitting, within the sidelink channel occupancy sharing indicator, an indication that COT sharing is to be performed in one of a frequency division multiplexing (FDM), time division multiplexing (TDM), and a combination of FDM and TDM; and
assigning the available COT to the at least two second UEs by mapping each second UE via one of a device ID and a resource index to respectively selected COT sub-channel resources in accordance with an interlacing configuration, wherein the interlacing configuration enables at least one second UE from among the at least two second UEs_to utilize first COT sub-channel resources via a multiple access protocol while at least one other UE from among the UE and one of the at least two second UEs utilizes second COT sub-channel resources.
